(19) United States
(12) Patent Application Publication
(10) Pub. No.: US 2026/0070455 A1
(43) Pub. Date: Mar. 12, 2026

(54) POWER TRANSFER CONTROL SYSTEM AND METHOD

(71) Applicant: Transportation IP Holdings, LLC, Norwalk, CT (US)

(72) Inventors: Gayathri Indra Seenumani, Niskayuna, NY (US); Kalpesh Singal, Ballston Spa, NY (US); Harry Kirk Matthews, Jr., Clifton Park, NY (US); Etika Agarwal, Bengaluru (IN)

(73) Assignee: Transportation IP Holdings, LLC, Norwalk, CT (US)

(21) Appl. No.: 19/108,289

(22) PCT Filed: Jul. 25, 2023
(86) PCT No.: PCT/US2023/070933

§ 371 Date: Mar. 3, 2025

Related U.S. Application Data
(60) Provisional application No. 63/403,059, filed on Sep. 1, 2022.

(51) Int. Cl. B60L 53/64; B60L 7/10; B60L 50/10; B60L 53/14; B60L 53/57

(52) U.S. Cl. CPC B60L 53/64; B60L 7/10; B60L 50/10; B60L 53/14; B60L 53/57; B60L 2240/642

(57) ABSTRACT

A power transfer control system and method include obtaining charge characteristics of multiple different charging options for charging an energy storage module onboard a vehicle system. The charge characteristics may include energy efficiency factors of the charging options and usage constraints of the charging options. The system and method may determine a charge plan for the vehicle system to implement while traveling on one or more routes based on the charge characteristics and route information. The charge plan may designate charging the energy storage module via different charging options along different segments of the one or more routes. The system and method may generate a control signal based on the charge plan.

### CROSS-REFERENCE TO RELATED APPLICATIONS

This application is a U.S. National Stage Entry under 35 U.S.C. § 371 of International Patent Application No. PCT/US2023/070933, entitled “POWER TRANSFER CONTROL SYSTEM AND METHOD,” filed Jul. 25, 2023, which claims benefit under 35 U.S.C. § 119(e) to U.S. Provisional Patent Application No. 63/403,059 , filed Sep. 1, 2022, and the entire disclosures of which are incorporated herein by reference in their entireties.

### BACKGROUND

### Technical Field

The subject matter described herein relates to transferring electrical power to an energy storage module of a vehicle system, where the electrical power stored in the energy storage module can be used to power propulsion of the vehicle system.

### Discussion of Art

Some vehicle systems are hybrid systems that include at least one fuel-consuming internal combustion engine and at least one energy storage module. Both types of power sources can be used to power propulsion of the hybrid vehicle system. For example, when a sufficient amount of electrical energy (e.g., amount of charge) is stored in the energy storage module, a vehicle controller of the hybrid vehicle system can selectively supply some of the electrical energy from the energy storage module to one or more traction motors of the vehicle system which convert the electrical energy to mechanical energy which rotates one or more wheels to propel the vehicle system along a route. The vehicle controller may control which power source is utilized to power propulsion at different times and/or locations during a trip of the hybrid vehicle system, and optionally may use both power sources to concurrently provide power for a period of time. The energy storage module is typically rechargeable and has to be periodically recharged for continued intermittent operation. The vehicle controller may implement regenerative or dynamic braking as the hybrid vehicle system travels along the route to harness energy for recharging the energy storage module.

Hybrid vehicle systems present an opportunity for movement optimization planning in order to achieve or improve one or more objectives for a given trip of a vehicle system, while abiding by a trip schedule. The objectives may include increased fuel efficiency (e.g., reduced fuel consumption) to complete the trip, reduced noise, reduced travel time, reduced wear on vehicle equipment, more consistent vehicle speeds (e.g., less acceleration and deceleration), and/or the like. For example, a control system can generate a trip plan that designates a first set of times in which the combustion engine powers propulsion of the vehicle system along the route, a second set of times in which the energy storage module powers propulsion of the vehicle system, and a third set of times in which the energy storage module is recharged via dynamic braking.

Control systems that control the distribution of power between power sources on a hybrid vehicle system typically only consider dynamic braking as a means to charge the energy storage module. The known control systems fail to consider or analyze charging options, other than dynamic braking. Some of the other charging options may require installation of additional equipment and/or infrastructure. Yet, fuel savings and/or other benefits attributable to those charging options may justify the capital expense of the installation. Furthermore, the known control systems may not consider how different charging options affect an operational life of the energy storage module. For example, using multiple different charging options to charge a battery pack onboard the vehicle system during a trip, and/or using at least one charging option other than dynamic braking, may cause less degradation of the battery pack than if only dynamic braking is used. Regardless of whether less fuel is consumed on the trip than if only dynamic braking is used, less battery degradation translates to an extended battery life, which is a cost savings by delaying a replacement battery pack.

It may be desirable to have a system and method that differs from those that are currently available.

### BRIEF DESCRIPTION

In one or more embodiments, a power transfer control system is provided that may include one or more processors configured to obtain charge characteristics of multiple different charging options for charging an energy storage module onboard a vehicle system. The charge characteristics may include energy efficiency factors of the charging options and usage constraints of the charging options. The one or more processors may determine a charge plan for the vehicle system to implement while traveling on one or more routes based on the charge characteristics and route information of the one or more routes. The charge plan may designate charging the energy storage module via a first charging option of the charging options along a first segment of the one or more routes and charging the energy storage module via a second charging option of the charging options along a different, second segment of the one or more routes. The one or more processors may generate a control signal based on the charge plan.

In one or more embodiments, a power transfer control system is provided that may include one or more processors configured to obtain charge characteristics of multiple different charging options for charging an energy storage module onboard a vehicle system. The charge characteristics may include energy efficiency factors of the charging options and usage constraints of the charging options. The one or more processors may determine a set of multiple charge plans based on the charge characteristics and route information of one or more routes. Each of the charge plans in the set may include a different configuration of one or more of the charging options for the vehicle system to utilize to charge the energy storage module while traveling on the one or more routes. The one or more processors may determine a consumption value for each of the charge plans in the set, and may either: (i) select a first charge plan in the set or (ii) generate a revised charge plan that is not in the set, based on an analysis of the consumption values of the charge plans in the set. The one or more processors may generate a control signal for the vehicle system to implement the first charge plan or the revised charge plan during a trip of the vehicle system.

In one or more embodiments, a method is provided that may include obtaining charge characteristics of multiple different charging options for charging an energy storage module onboard a vehicle system. The charge characteristics may include energy efficiency factors of the charging options and usage constraints of the charging options. The method may include determining, via one or more processors, a charge plan for the vehicle system to implement while traveling on one or more routes based on the charge characteristics and route information of the one or more routes. The charge plan may designate charging the energy storage module via a first charging option of the charging options along a first segment of the one or more routes and charging the energy storage module via a second charging option of the charging options along a different, second segment of the one or more routes. The method may include generating a control signal based on the charge plan.

In one or more embodiments, a method is provided that may include obtaining charge characteristics of multiple different charging options for charging an energy storage module onboard a vehicle system. The charge characteristics may include energy efficiency factors of the charging options and usage constraints of the charging options. The method may include determining, via one or more processors, a set of multiple charge plans based on the charge characteristics and route information of one or more routes. Each of the charge plans in the set may include a different configuration of one or more of the charging options for the vehicle system to utilize to charge the energy storage module while traveling on the one or more routes. The method may include determining a consumption value for each of the charge plans in the set, and one of: (i) selecting a first charge plan in the set or (ii) determining a revised charge plan that is not in the set, based on an analysis of the consumption values of the charge plans in the set. The method may include generating a control signal for the vehicle system to implement the first charge plan or the revised charge plan during a trip of the vehicle system.

### BRIEF DESCRIPTION OF THE DRAWINGS

The inventive subject matter may be understood from reading the following description of non-limiting embodiments, with reference to the attached drawings, wherein:

FIG. 1 illustrates a power transfer system including a vehicle system, an external power supply system, and an extra-vehicle transmission line according to an embodiment;

FIG. 2 illustrates a vehicle system with a hybrid convoy (e.g., hybrid consist/propulsion/powertrain/system) according to an embodiment;

FIG. 3 is a block diagram of a power transfer control system according to an embodiment;

FIG. 4 is a diagram showing a vehicle system on a route according to an embodiment; and

FIG. 5 is a flow chart of a method of controlling power transfer to an energy storage module onboard a vehicle system along one or more routes according to an embodiment.

### DETAILED DESCRIPTION

Embodiments of the subject matter described herein relate to a power transfer control system that evaluates multiple different charging options for charging an energy storage module onboard a vehicle system. The power transfer control system may explore energy efficiency gained and/or energy storage module life preserved, which may be attributable to implementing one or more charging options instead of, or in addition to, dynamic braking. The power transfer control system may also consider route information to select corresponding times and/or locations along one or more routes at which to initiate each charging operation. The power transfer control system may determine a charge plan, based on the analysis of the different charging options and the route information, for the vehicle system to implement while traveling on the one or more routes. The charge plan may designate specific types of charging options and locations and/or times at which to initiate each charging option. The charge plan may be communicated to a vehicle controller device and/or a human operator for controlling the charging of the energy storage module onboard the vehicle system according to the charge plan.

The vehicle systems described herein may be hybrid vehicles in a sense that the electrical energy stored in the energy storage module can be used to power movement of the vehicle system. For example, propulsion of the vehicle system at a given moment may be powered by one or more internal combustion engines and/or one or more energy storage modules. An energy storage module may power propulsion by supplying electrical power from the energy storage module to one or more traction motors mechanically connected to axles and/or wheels of the vehicle. The traction motors generate torque that rotates the wheels and propels the vehicle system along a route.

The power transfer control system may enable a vehicle system, that charges during a trip according to a charge plan generated by the control system, to meet or exceed certain travel objectives. The travel objectives may include reducing fuel consumption by the vehicle system, improving energy efficiency, limiting wear of equipment (including degradation of the energy storage module), and/or the like. The objectives may be compared to a baseline movement plan, such as charging via dynamic braking only. Particularly, the baseline movement plan may charge whenever dynamic braking is available and the energy storage module has less than a designated level of charge. The power transfer control system may operate based on the premise that fuel savings and/or other benefits may be achieved by selectively charging the energy storage module (e.g., keeping the energy storage module charged at determined times and/or locations). The control system may charge the energy storage module when a potential for fuel savings is high along an upcoming segment of route. For example, supplying electrical power from the energy storage module to the traction motors to supplement tractive effort provided by the combustion engine while the vehicle system travels along an incline grade may save fuel and provide a power boost that enables the vehicle system to traverse the incline in less time (relative to only the combustion engine providing propulsion).

The power transfer control system can be used for prospective purposes, such as to evaluate whether it would be beneficial, particularly from a cost standpoint, to invest in charging infrastructure along one or more routes. For example, one of the charging options considered may be an extra-vehicle transmission line, such as a catenary, third rail, or inductive coil, which supplies electrical power to the vehicle system from an off-board, external power supply system. The power transfer control system is a tool that may help a user understand beneficial charging options specific to a particular use application (e.g., type of vehicle system, route(s) traversed during a trip, etc.).

The vehicle system according to one or more embodiments is a rail vehicle system, such as a train, but not all embodiments are limited to rail vehicle systems. Unless expressly disclaimed or stated otherwise, the inventive subject matter described herein extends to other types of vehicles, such as buses, trucks (with or without trailers), automobiles, mining vehicles, agricultural vehicles, or other off-highway vehicles. The vehicles described herein (rail vehicles or other vehicles that do not travel on rails or tracks) can be part of a single vehicle system or a vehicle system of multiple vehicles. With respect to vehicle systems, the vehicles in the vehicle system can be mechanically coupled with each other (e.g., by couplers). For example, hybrid convoys described herein may include at least first and second propulsion-generating vehicles that are directly or indirectly coupled together. The first and second propulsion-generating vehicles may be rail vehicles in some embodiments, and may be non-rail vehicles in other embodiments. The term hybrid convoy as used herein is not limited to rail applications, and may refer to hybrid consists, propulsion systems, powertrains, and/or the like. Optionally, an electrically conductive transmission line may extend from the first vehicle to the second vehicle. In an alternative embodiment, vehicles in a vehicle system may be logically coupled but not mechanically coupled. For example, vehicles may be logically but not mechanically coupled when the discrete vehicles communicate with each other to coordinate movements of the vehicles with each other so that the vehicles travel together (e.g., as a convoy).

The power transfer control system may be a computer-based model that has one or more functions with parameters that are reconfigured based on different charging options. The model may be continuous and smooth for integration into trip planning software. The power transfer control system may be part of an energy management system for planning and controlling operations of the vehicle system. For example, the power transfer control system may be integrated into Trip Optimizer™ of Wabtec Corp. The Trip Optimizer™ may generate a trip plan for the vehicle system to travel along a route to a destination location. The trip plan may designate tractive and brake settings to be implemented by the vehicle system at different times and locations during a particular trip of the vehicle system with the intention of meeting or exceeding one or more objectives, such as to increase fuel efficiency, reduce noise, travel with a more consistent speed, and/or the like relative to traveling according to different control settings. The charge plan generated by the power transfer control system may be incorporated into the trip plan.

The charging options are different mechanisms for supplying electrical energy to the energy storage module to increase the charge level (e.g., amount of electrical energy stored in the energy storage module). One charging option is regenerative or dynamic braking, referred to herein as dynamic braking. Dynamic braking uses one or more traction motors onboard the vehicle system to function as generators, converting kinetic energy of the moving vehicle system into electrical energy that is conveyed to the energy storage module. Another charging option is referred to herein as intra-vehicle transmission line charging. The intra-vehicle transmission line charging uses a conductive pathway onboard a vehicle of the vehicle system to transfer electrical energy to the energy storage module from a generator that is powered by a combustion engine. The generator may be mechanically connected to the combustion engine via a linkage. The energy storage module, generator, combustion engine, and conductive pathway may all be disposed on a common vehicle of the vehicle system, which may be referred to as a first vehicle. Typically, the combustion engine provides vehicle propulsion by powering the generator, and the generator supplies electrical energy that powers one or more traction motors connected to the wheels of the vehicle. The intra-vehicle transmission line charging option, when active, may selectively syphon at least some of the electrical energy from the generator through the intra-vehicle transmission line to the energy storage module for charging the energy storage module. The intra-vehicle transmission line may include one or more electrical wires, cables, and/or switch devices that define a conductive pathway between the generator and the energy storage module.

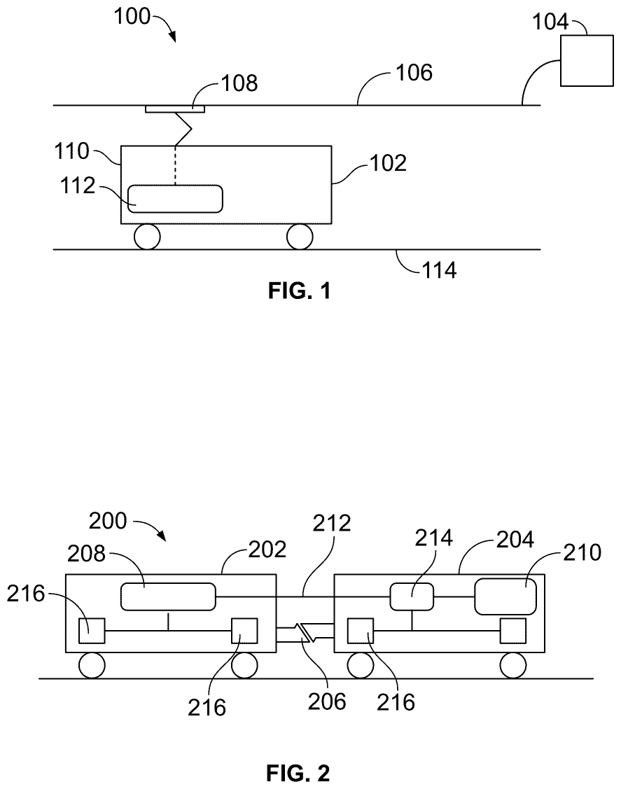

FIG. 1 illustrates a power transfer system 100 including a vehicle system 102, an external power supply system 104, and an extra-vehicle transmission line 106 according to an embodiment. The power transfer system provides another charging option. The extra-vehicle transmission line supplies electrical power from the external power supply system to the vehicle system. The extra-vehicle transmission line may be a catenary line, a powered third rail, or the like. The vehicle system may include a collector shoe 108 that is mounted to a body 110 of the vehicle system. The collector shoe may be a component of a pantograph. The collector shoe includes electrical conductors that may physically and electrically connect to the extra-vehicle transmission line to establish an electrically conductive pathway between the external power supply system and the vehicle system. Onboard the vehicle system, the collector shoe may be electrically connected via a conductive pathway to an energy storage module 112 disposed onboard the vehicle system.

The energy storage module stores electrical energy. The energy storage module may include a battery pack. The battery pack may have multiple battery cells. The battery cells may be lithium-ion cells, nickel manganese cobalt cells, nickel metal hydride cells, lithium sulfur cells, lead-acid cells, and/or the like. The cell chemistries may be based on the desired properties of the energy storage module with respect to specific use applications. The battery cells may be electrically connected in series and/or parallel relationship. Optionally, the energy storage module may include one or more other devices other than battery cells, either instead of or in addition to battery cells. The other devices may include capacitors, flywheel energy storage devices, and/or the like. References herein to an energy storage module are inclusive of the various ways that the cells or other sub-components can be assembled together within the module, such as in strings and banks.

During a charging operation, electrical power from the external power supply system may be conveyed through the extra-vehicle transmission line through the collector shoe to the energy storage module. The external power supply system may include a wayside energy storage device, a wayside system that is connected to a power network, and/or the like. The extra-vehicle transmission line may extend along a segment of a route 114, and the collector shoe may receive the electrical power from the extra-vehicle transmission line as the vehicle system travels along the segment of the route. In an alternative aspect, the extra-vehicle transmission line may be next to a single, discrete location along the route, such that the vehicle system charges by stopping and remaining stationary at the location for a duration of the charging operation. For example, the external power supply system may include a pantograph that defines a portion of the extra-vehicle transmission line and makes contact with the collector shoe of the vehicle system.

One or more charging options may be applicable for hybrid convoys (e.g., consists). A hybrid convoy may include at least two propulsion-generating vehicles of the vehicle system that are mechanically coupled together, either directly or indirectly through one or more intervening vehicles of the vehicle system. FIG. 2 illustrates a vehicle system 200 with a hybrid convoy according to an embodiment. The hybrid convoy may be a hybrid consist, propulsion system, and/or powertrain, and is not limited to rail applications. The vehicle system includes a first propulsion-generating vehicle 202 and a second propulsion-generating vehicle 204. The two vehicles are mechanically coupled by couplers 206. Each of the propulsion-generating vehicles may include a respective propulsion system for generating tractive effort to propel the vehicle system. In one example, the first propulsion-generating vehicle of the hybrid convoy includes an energy storage module 208, and the second propulsion-generating vehicle of the hybrid convoy includes a fuel-consuming internal combustion engine 210.

One or more charging options may charge the energy storage module disposed onboard the first vehicle based on operation of the combustion engine onboard the second vehicle. For example, the propulsion system onboard the second vehicle may function as an electrical power source for charging the energy storage module onboard the first vehicle. One example charging option uses an inter-vehicle transmission line 212 that extends from the second propulsion-generating vehicle to the first propulsion-generating vehicle. This charging option is referred to as inter-vehicle transmission line. The inter-vehicle transmission line may be electrically connected to a generator 214 disposed onboard the second vehicle. The generator is mechanically connected to the combustion engine. The generator optionally may be an alternator that converts mechanical energy to alternating current. The generator and combustion engine may be a generator set (e.g., genset). Some of the electrical power output from the generator may be selectively conveyed along the inter-vehicle transmission line to the first propulsion-generating vehicle, where the electrical power is directed to the energy storage module for charging. The inter-vehicle transmission line may include one or more electrical cables and/or wires. The inter-vehicle transmission line may be a high voltage line. The high voltage line may be rated for handling electrical power in excess of 2 kV.

Another charging option that is available for hybrid convoys is referred to herein as consist dragging. Consist dragging charges the energy storage module onboard the first propulsion-generating vehicle by operating the propulsion system onboard the second vehicle in a motoring mode. The second vehicle generates tractive effort for propelling the vehicle system while concurrently operating the propulsion system of the first vehicle in the dynamic braking mode. In the dynamic braking mode, as described above, one or more traction motors 216 of the first vehicle operate as generators to convert kinetic energy into electrical energy that is conveyed to the energy storage module. Essentially, the tractive effort provided by the second vehicle of the vehicle system is used to charge the energy storage module on the first vehicle of the vehicle system. The first vehicle in the dynamic braking mode may be dragged or pushed by the second vehicle in the motoring mode during the charging operation. Optionally, consist dragging may include more than two propulsion-generating vehicles of a common vehicle system. For example, two vehicles in the motoring mode may push and/or drag a third vehicle that is in the dynamic braking mode to charge an energy storage module on the third vehicle. Likewise, one vehicle in the motoring mode may push and/or drag a second vehicle and a third vehicle in the dynamic braking mode to charge energy storage modules on both the second and third vehicles. The consist dragging can be performed even if the inter-vehicle transmission line shown in FIG. 2 is not present, as the mechanical energy used to generate the electrical energy is transferred via the couplers.

At least some of the charging options may have different electrical power sources for supplying electrical power used to charge the energy storage module onboard a first vehicle of the vehicle system. For example, the intra-vehicle transmission line charging option uses the generator onboard the first vehicle as the electrical power source. The generator is powered by the combustion engine of the first vehicle. The electrical power source for the dynamic braking charging option may be one or more traction motors onboard the first vehicle in the dynamic braking mode of operation. The electrical power source associated with the inter-vehicle transmission line may be the generator (e.g., a second generator) that is disposed onboard the second propulsion-generating vehicle of the vehicle system. The second generator is powered by the combustion engine of the second vehicle. The electrical power source associated with the extra-vehicle transmission line is the external power supply system that is disposed off-board the vehicle system.

One or more embodiments may consider one or more different charging options for charging the onboard energy storage module during a trip. Examples of additional charging options may include solar powered charging via onboard photovoltaic cells, wind powered charging, fuel cell charging, and/or the like.

The charging options have different charge characteristics. The charge characteristics may include energy efficiency factors and usage constraints. The energy efficiency factor of a respective charging option is a value that represents energy efficiency of the charging option. For example, the energy efficiency factor may represent a measure of the amount of electrical power output to charge the energy storage module, via the charging option, relative to input amount of energy. Optionally, the energy efficiency factor may be representative of an amount of fuel displacement attributable to the charging option. For example, charging the energy storage module using dynamic braking and then using that stored energy to power propulsion of the vehicle system may conserve a first amount of fuel by limiting the amount of fuel that is consumed by the combustion engine. Charging the energy storage module using another charging option, such as an extra-vehicle transmission line, and then using that stored energy to power propulsion of the vehicle system may conserve a second amount of fuel by limiting the fuel consumed by the combustion engine. The varying amounts of fuel consumed may be attributable to various factors, such as the energy efficiency of the charging option, the weight of charging equipment and/or fuel carried by the vehicle system, the movement characteristics of the vehicle system, and/or the like. The power transfer control system may use the energy efficiency factors as constants and/or weighting/scaling factors in one or more functions or a model and/or neural network.

As an example, the energy efficiency factor of the extra-vehicle transmission line charging option may be greater (e.g., more efficient) than the efficiency factor of the inter-vehicle transmission line charging option because fuel is carried and consumed by the vehicle system in order to charge the energy storage module in the inter-vehicle transmission line charging option. The vehicle system may be lighter and consume less fuel using the extra-vehicle transmission line charging option to charge the energy storage module. In another example, the energy efficiency factor of the inter-vehicle transmission line charging option may be greater than the efficiency factor of the consist dragging charging option because transferring electrical power through the transmission line may be more efficient that transferring electrical energy to mechanical energy through the traction motors and other mechanical components, and then using more traction motors and other mechanical components to transfer mechanical energy back to electrical energy.

The usage constraints of the charge characteristics represent limitations on the use of the charging options. The usage constraints may include infrastructure along the routes, equipment onboard the vehicle system, and other conditions that are necessary in order to utilize each respective charging option. Besides hardware constraints, utilization of charging options may be constrained by time of day limitations, weather limitations, movement characteristics of the vehicle system, and/or the like. The time of day limitations may include time of day variations in charging costs from an external source. The usage constraints are considered because even though a first type of charging option may be more energy efficient than a second charging option, the energy efficiency is moot if the first charging option is not available to charge the energy storage module when the energy storage module needs to charge and/or the first charging option is prohibitively more expensive than the second charging option. As an example, the extra-vehicle transmission line may be more energy efficient that one or more other charging options, but that charging option requires substantial infrastructure along the route (in the form of the transmission line and external power supply system) and equipment onboard the vehicle system (in the form of a collector shoe). The extra-vehicle transmission line may only be available in a few select segments of the routes traversed by the vehicle system. The vehicle system is not able to charge the energy storage module via the extra-vehicle transmission line outside of those segments of the routes due to lack of infrastructure, weak power grids, and/or the like.

With respect to the dynamic braking charging option, one usage constraint is that the vehicle system needs to be braking (e.g., in the dynamic braking mode) in order to charge the energy storage system. The dynamic braking charging option can be used on a vehicle system that has only a single vehicle, but cannot be used while that vehicle is in a motoring mode providing tractive effort to propel the vehicle. A usage constraint specific to the intra-vehicle transmission line charging option is the installation of hardware, such as an electrically conductive cable, switch devices, and other circuitry, for selectively conveying electrical power from the generator (e.g., genset) to the energy storage module.

The inter-vehicle transmission line charging option and the consist dragging charging option both require a hybrid convoy including two propulsion-generating vehicles. Vehicle systems that only have one propulsion-generating vehicle cannot use either of these charging options to charge the onboard energy storage module. An additional usage constraint specific to the inter-vehicle transmission line charging option is the installation of the transmission line (e.g., cable) that extends from the energy storage module on a first vehicle to the generator on a second vehicle of the hybrid convoy, as well as circuitry that controls electrical power through the transmission line.

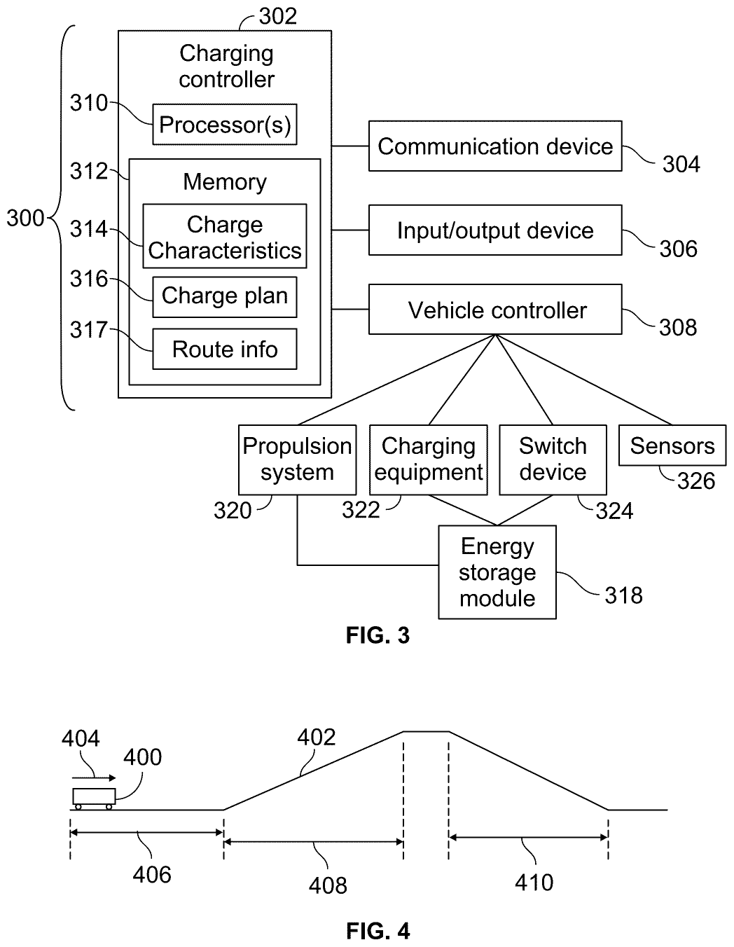

FIG. 3 is a block diagram of a power transfer control system 300 according to an embodiment. The power transfer control system includes a charging controller 302 (e.g., charging control unit or control circuit). The power transfer control system may also include a communication device 304, an input/output device 306, and/or a vehicle controller 308. The power transfer timing system in FIG. 3 may be disposed onboard a vehicle system, such as the vehicle system shown in FIG. 1 or the vehicle system shown in FIG. 2. The power transfer control system may interact, directly or indirectly, with one or more additional components onboard the vehicle system, such as the propulsion system 320, charging equipment 322, switch devices 324, an energy storage module 318, and/or sensors 326.

The charging controller includes one or more processors 310. The charging controller refers to the one or more processors that perform some or all of the operations described herein to analyze charging options and generate a charge plan that dictates how, when, and/or where to charge the energy storage module onboard the vehicle system, as well as supplemental actions performed based on the generated charge plan. The charging controller is also referred to herein simply as controller. The controller may be operably connected to the other components of the power transfer control system via wired and/or wireless communication links to permit the transmission of information in the form of signals. For example, the controller may generate control signals that are transmitted to the other components to control operation of the components. The power transfer control system may have additional components that are not shown in FIG. 3. In an alternative embodiment, the power transfer control system may lack one or more of the components that are shown in FIG. 3.

The controller represents hardware circuitry that includes the one or more processors 310 (e.g., one or more microprocessors, integrated circuits, microcontrollers, field programmable gate arrays, etc.). The controller may represent one or more control units or devices that are operably connected to perform the operations described herein. In an embodiment, the one or more processors may be disposed in a single, unitary control unit (e.g., a single piece of hardware equipment). In another embodiment, the controller may include multiple processors distributed among multiple different hardware devices (e.g., computers, servers, mobile devices, integrated onboard devices, etc.) which communicate with each other to perform the functions described herein associated with the charging controller.

The controller includes and/or is connected with a tangible and non-transitory computer-readable storage medium (e.g., data storage device), referred to herein as memory 312. The memory may store program instructions (e.g., software) that are executed by the one or more processors to perform the operations described herein. The program instructions may include one or more algorithms utilized by the one or more processors to analyze the charge characteristics and route information which affect the ability and efficiency of charging the energy storage device. The program instructions may provide functions, models, and/or neural networks used to generate charge plans and optionally also to compare multiple different charge plans or revise a charge plan. The program instructions may further dictate actions to be performed by the one or more processors. One action may be to send a message for notifying an operator of the vehicle system about the recommended charge plan and/or about suggested charging infrastructure and/or equipment to install. Another action may be to communicate control signals to the vehicle controller for automatically controlling operations of the vehicle system according to the charge plan.

The memory may store additional information that is used by the controller. For example, the memory may include a database 314 for storing charge characteristics about the different charging options, a database 317 that includes route information about one or more routes that the vehicle system may traverse, and/or one or more charge plans generated by (or at least obtained by) the controller. For example, upon generating a set of charge plans, the controller may store the set in the memory, at least temporarily, in order to analyze the charge plans. The route information may include a map of routes that may be traversed by the vehicle system, including one or more routes associated with a scheduled trip of the vehicle system. The route information may also include grade information about the routes, such as the locations of hills, as well as the type and locations of charging infrastructure along the routes. The memory optionally may store applications, such as various application program interfaces (APIs) that link to cloud hosting services, via the communication device, for accessing information from remote storage devices (e.g., servers).

The communication device represents hardware circuitry that can communicate electrical signals via wireless communication pathways and/or wired conductive pathways. The communication device may include transceiving circuitry, one or more antennas, and the like, for wireless communication. The communication device may communicate directly with a client computer device (e.g., smartphone, tablet computer, laptop computer, etc.) of the operator of the vehicle system or indirectly via a cellular tower, a modem, a router, and/or the like. For example, the controller may control the communication device to send a message to the client computer device of the operator. The message may include one or more charge plans generated by the controller. The charge plan may indicate control settings for the vehicle system to implement along the one or more routes to charge the energy storage module.

The input/output (I/O) device allows an operator to receive information from the controller and optionally to interact with the power transfer control system by submitting user inputs. The I/O device may include one or more input devices designed to generate user command signals (e.g., selections) based on user manipulations. For example, an input device may include or represent a touch sensitive screen or pad, a mouse, a keyboard, a joystick, a switch, a microphone, physical buttons, and/or the like. The I/O device may include a display device having a display screen that presents graphical indicia, such as text and symbols, for viewing by the user. The controller may notify an operator of the charge plan by displaying a message on the screen of the display device. Optionally, the I/O device may include an audio speaker, one or more signal lights, and/or the like, for notifying and/or conveying information to the operator.

The selective charging of the energy storage module may be accomplished by actuation of the one or more switch devices. The switch devices can provide, and break (e.g., block), conductive pathways between the energy storage module and other components to establish one or more of the charging options. For example, one or more switch devices may be actuated to conductively connect the charging equipment onboard the vehicle system to the energy storage module. The charging equipment may include a collector shoe (e.g., pantograph) or an inter-vehicle transmission line. In another example, one or more switch devices may be actuated to conductively connect the propulsion system, such as the generator thereof, to the energy storage module for establishing the intra-vehicle transmission line charging option. Furthermore, the switch devices may be used to switch modes of the vehicle system, such as to select between the dynamic braking mode and the motoring mode of operation. The switch devices may include electromechanical devices, such as relays and/or contactors. Optionally, the switch devices may include solid state switches, such as field-effect transistors (e.g., metal-oxide semiconductor field-effect transistors (MOSFETs)), insulated-gate bipolar transistors (IGBTs), and the like. The switch devices are communicatively connected to the controller via wireless or wired communication pathways, and are actuated via electrical signals (e.g., the presence and absence of an applied electrical voltage).

Once a charge plan is generated, the vehicle controller and/or human operator of the vehicle system may rely on the one or more sensors to monitor movement of the vehicle system and implement the charge plan. For example, the sensors may include a location determining sensor, such as a GPS receiver, that allows the vehicle controller to track progress of the vehicle system along the routes. Once the vehicle system reaches a designated location in which to charge the energy storage module according to the charge plan, the vehicle controller may generate one or more control signals to actuate appropriate switch devices to charge the energy storage module via one of the charging options.

In one or more embodiments, the controller (e.g., charging controller) obtains the charge characteristics of multiple different charging options for charging the energy storage module onboard the vehicle system. The charge characteristics may include the energy efficiency factors of the charging options and the usage constraints of the charging options. Optionally, the charge characteristics may be stored in the memory of the controller. The one or more processors of the controller may obtain the charge characteristics by accessing the memory. Alternatively, the controller may obtain the charge characteristics from a remote storage device (e.g., server) via the communication device and/or a network connection.

The controller may obtain route information specific to one or more routes that the vehicle system may traverse. The routes may be associated with one or more scheduled trips of the vehicle system. Each route may represent a street, set of tracks, or the like, on which the vehicle system travels. A scheduled trip may require the vehicle system to traverse along multiple routes to reach a destination location. The route information may include charging infrastructure that is available for charging the energy storage module, such as the location and type of any extra-vehicle transmission line (e.g., catenary, inductive coil, electrified third rail, etc.). For example, the route information may identify a first set of one or more segments along the route(s) that include an extra-vehicle transmission line (or a second set of one or more segments that do not include any extra-vehicle transmission line). This information about the presence of extra-vehicle transmission lines may constitute a usage constraint for the extra-vehicle transmission line charging operation.

Optionally, the controller may obtain vehicle information specific to the vehicle system. The vehicle information may include information about the energy storage module, such as charging capacity, charge threshold, age, and/or the like. The vehicle information may also include information about the charging equipment onboard the vehicle system, such as the presence of any inter-vehicle transmission line, hybrid convoy, collector shoe, pantograph, intra-vehicle transmission line, and/or the like. This information about the presence of charging equipment onboard may constitute usage constraints for one or more of the charging operations. For example, the inter-vehicle transmission line charging option is not available if the inter-vehicle transmission line is not present and installed. The charge characteristics, route information, and/or vehicle information may be used as inputs to generate one or more charge plans.

The controller may determine a charge plan for the vehicle system to implement while traveling on one or more routes based on the charge characteristics, route information of the one or more routes, and/or vehicle information. The charge plan may be an ordered plan that provides times and/or locations along the route(s) at which to charge the energy storage module, as well as the type of charging option to use for each charging operation. The charge plan may designate charging the energy storage module via a first charging option along a first segment of the one or more routes and charging the energy storage module via a second charging option along a different, second segment of the one or more routes. The first segment may be identified by a time elapsed during the trip or a location along the route. For example, in accordance with the charge plan, when the vehicle controller determines (via the sensors) that the vehicle system has reached the first segment, the vehicle controller may generate one or more control signals. The control signals generated by the vehicle controller may actuate one or more of the switch devices to initiate the first charging option. The energy storage module may continue to charge until either the energy storage module reaches a designated threshold charge level or the vehicle system exits the first segment. At that point, the vehicle controller may actuate the switch devices to deactivate the first charging option. A similar sequence may be followed by the vehicle controller upon determining that the vehicle system has reached the second segment of the route(s), except that the vehicle system may actuate one or more different switch devices to initiate the second charging option. In an alternative embodiment, the charging controller that generates the charge plan may generate the control signals that actuate the switch devices and control the charging operations, rather than the vehicle controller. Optionally, the charging controller may be integrated with the vehicle controller.

The first and second charging options may be two of the charging options described herein. The controller may generate the charge plan to select the first and second charging options based on the inputs. For example, the controller may determine that the first charging option is one of, if not the most, energy efficient charging option that is available along the first segment, which is a location at which the energy storage module should be charged in order to achieve fuel savings during an upcoming segment of the routes by contributing to the propulsion of the vehicle system. If there is no extra-vehicle transmission line along the first segment, then the extra-vehicle transmission line charging option is not selected as the first charging option. Similarly, the controller may determine that the second charging option is one of, if not the most, energy efficient charging option that is available along the second segment, which follows the first segment along a direction of travel of the vehicle system. The second charging option may be used to recharge the energy storage module after the intervening segment in which the energy storage module supplied electrical power for propulsion. The second segment may also be a location at which the energy storage module should be charged in order to achieve fuel savings during another upcoming segment of the routes by contributing to the propulsion of the vehicle system. For example, the controller may not generate the charge plan to recharge the energy storage module unless that charge will be put to use in the short term. If the vehicle system is about to reach the destination location of the trip, without departing shortly on a subsequent trip, there is no need to recharge the energy storage module because that charge may be wasted and the charging operation may unnecessarily degrade the energy storage module.

In an embodiment, the controller may generate the charge plan to cause the vehicle system to travel along the one or more routes with greater energy efficiency, less fuel consumption, and/or less cost per mile relative to the vehicle system traveling along the one or more routes using only dynamic braking to charge the energy storage module. In the example above, dynamic braking may be selected as one of the charging options, but the other charging option may be a different charging option. The controller may select the different charging option over dynamic braking because the other charging option may be more energy efficient than dynamic braking, may cause less wear (e.g., degradation) of the vehicle components than dynamic braking, and/or may allow the vehicle system to charge the energy storage module without braking, which is a usage constraint of dynamic braking. Optionally, neither of the first or second charging option in dynamic braking. The charge plan may include more than two charging options and/or more than two charging operations. For example, the charge plan may designate a third charging operation along a third segment of the routes. The third charging operation may use the first charging option again, the second charging option again, or a different, third charging option.

The first segment of the one or more routes may represent a first portion of a scheduled trip of the vehicle system, and the second segment may represent a second portion of the scheduled trip. For example, the vehicle system may charge the energy storage module according to the first charging option while the vehicle system travels along the first segment. After the first segment, the energy storage module may be controlled, according to the charge plan and/or a discrete trip plan, to supply electrical power to power propulsion of the vehicle system along a subsequent segment of the trip. This may deplete the charge of the energy storage module, so the second charging option is used to recharge the energy storage module upon reaching the second segment of the trip. After recharging, the energy storage module may again be controlled to contribute electrical power for propulsion. This pattern may repeat over the course of the trip.

FIG. 4 is a diagram showing a vehicle system 400 on a route 402 according to an embodiment. The charge plan described above may be generated by the controller to control charging and discharging of the energy storage module onboard the vehicle system while traveling on the route in the direction of travel 404. The vehicle system is shown traveling on a first segment 406 of the route. An uphill or incline grade segment 408 of the route follows the first segment. A downhill or decline segment 410 of the route follows shortly after the uphill segment. The controller recognizes, based on the route information that identifies the uphill section, that the energy storage module can supply power to provide a propulsion boost as the vehicle system travels along the uphill segment. As such, the charge plan may designate charging the energy storage module according to the first charging option as the vehicle system travels along the first segment, to ensure that the energy storage module has sufficient charge to provide adequate boost upon reaching the uphill segment. The first charging option may represent or include consist dragging, inter-vehicle transmission line, inter-vehicle transmission line, or extra-vehicle transmission line, depending on the constraints.

The downhill segment may represent the second segment according to the charge plan. For example, the charge plan may designate charging the energy storage module using the second charging option as the vehicle system travels along the decline grade. Optionally, the second charging option may be dynamic braking, as the vehicle system may need to brake to retain a set speed down the hill. Recharging the energy storage module prepares the energy storage module to provide additional propulsion during a subsequent segment of the trip to reduce fuel consumption.

In another example, the first segment of the routes may represent a first scheduled trip of the vehicle system, and the second segment may represent a different, second scheduled trip of the vehicle system. During the first trip, the vehicle system may use only the first charging option. The vehicle system may use only the second charging option during the second trip.

In an embodiment, the controller determines multiple charge plans and analyzes the charge plans. Each of the charge plans has a different configuration of one or more charging options used to charge the energy storage module along the same one or more routes, such that the charge plans are alternatives. The configuration refers to the types of charging options used and the route segments on which charging occurs. For example, the set may include the first charge plan that designates the first charging option along the first segment of the routes and the second charging option along the second segment. The set may also include a second charge plan that designates the first charging option along both the first and second segments of the routes (without using the second charging option). As stated, the charge plans may have any number of charging operations during the course of a trip, not just two. Optionally, one or more of the configurations are selected by an operator using the I/O device. For example, the operator may want to compare specific charging options.

The controller may compare the charge plans to select one of the charge plans as a recommended charge plan. Alternatively, the controller may analyze the charge plans to determine a new, revised charge plan. For example, the controller may use the previous charge plans in an optimization function or model to select the configuration of the revised charge plan, in an attempt to generate a more preferred charge plan.

In either case (e.g., selecting a charge plan from the set or generating a revised charge plan), the controller may analyze the charge plans by determining a consumption value for each of the charge plans in the set. The consumption value may represent an estimated fuel consumption of the vehicle system on the trip, an estimated fuel savings of the vehicle system on the trip, an estimated battery life consumption of the vehicle system on the trip, an estimated travel time of the vehicle system on the trip, and/or an estimated vehicle equipment wear on the trip, according to the respective charge plan. If the first charge plan has a greater estimated fuel savings than the second charge plan, the controller may rank the first charge plan higher than the second charge plan during the analysis. For example, the controller may select the first charge plan over the second charge plan as the recommended charge plan, or may weigh or rely on the first charge plan more than the second charge plan to generate the revised charge plan.

In one embodiment, the controller may compare the consumption values of the charge plans in the set, and may select one of the charge plans as the recommended charge plan based on the consumption value. The recommended charge plan may have a more preferable consumption value, either greater or smaller, than the consumption values of all or at least some of the other charge plans in the set.

In another embodiment, the controller may generate the revised charge plan based on the analysis of the charge plans and the consumption values thereof. The revised charge plan may be tailored towards the more preferable charge plans in the set. The controller may continue this sequence for multiple iterations to focus or hone-in on a more optimal charge plan, compared to an initially generated charge plan. This process may be supervised by an operator and used to train an artificial neural network for generating the charge plans.

After selecting the recommended charge plan and/or generating the revised charge plan, the controller may generate a control signal for the vehicle system to implement the recommended charge plan and/or revised charge plan. The recommended charge plan and the revised charge plan are commonly referred to in the following paragraphs as an output charge plan. The control signal may be transmitted to the vehicle controller to control charging and discharging of the energy storage module along the one or more routes according to the output charge plan. More generally, the charge plan may be used to control movement of the vehicle system, as discharging of the energy storage module may provide electrical power for propulsion of the vehicle system. More specifically, the vehicle controller may implement the output charge plan by selectively actuating switch devices and/or other circuitry to control current into and from the energy storage module, according to the output charge plan, based on progress of the vehicle system along the routes.

Optionally, a control signal generated based on the output charge plan may control the communication device and/or the I/O device to send a message to the operator of the vehicle system. For example, the communication device may wirelessly transmit the message to a client computer device (e.g., smartphone) of the operator. In another example, the control signal may cause the I/O device to display the message on a display screen. The message may identify and provide information about the output charge plan. Optionally, the message may include multiple output charge plans and enable the operator to select one of the charge plans to implement. The information about the charge plan may include control settings for the vehicle system to implement along the one or more routes to charge the energy storage module during the trip according to the output charge plan. The information may also include the consumption values associated with the charge plans in the set. The operator may be presented with the ability to select and approve the output charge plan. After approval, the vehicle controller may automatically implement the approved charge plan during travel of the vehicle system. Optionally, a copy of the message may be sent to an off-board control system, such as a server.

In an embodiment, the output charge plan may be based on prospective charging infrastructure that is not currently present along one or more segments of the one or more routes. For example, the operator may select for the charging controller to ignore one or more usage constraints that currently exist in order to consider prospective infrastructure. A specific example is to investigate charge plans that involve extra-vehicle transmission lines (e.g., catenary, third rail, inductive coil, etc.), along one or more route segments that do not currently have the infrastructure. The controller may compare such prospective charge plans with other charge plans based on the existing infrastructure available, to estimate the benefits achieved by installing new infrastructure. The controller may compare the benefits to the capital costs of the new infrastructure to generate a recommendation regarding installing the prospective charging infrastructure along the one or more segments.

In another example, the power transfer control system may factor the degradation of the energy storage module into an estimated cost associated with replacing the energy storage module at end of life. For example, cycling a battery pack by charging and discharging may slowly degrade the battery pack over time. The control system may use an estimated cost of a replacement energy storage module and an estimated degradation attributable to each charge cycle to generate a capital cost-based value associated with each charge plan. The capital cost value of the energy storage device may be added to any infrastructure and/or equipment costs in order to accommodate a new charging option to determine a total cost. The cost reduces the savings attributable to less fuel consumed. The control system may factor these costs when comparing the different charge plans and selecting the recommended plan and/or generating the revised plan, such that the output plan is more cost-effective than all or at least some of the other charge plans, at least over a period of time.

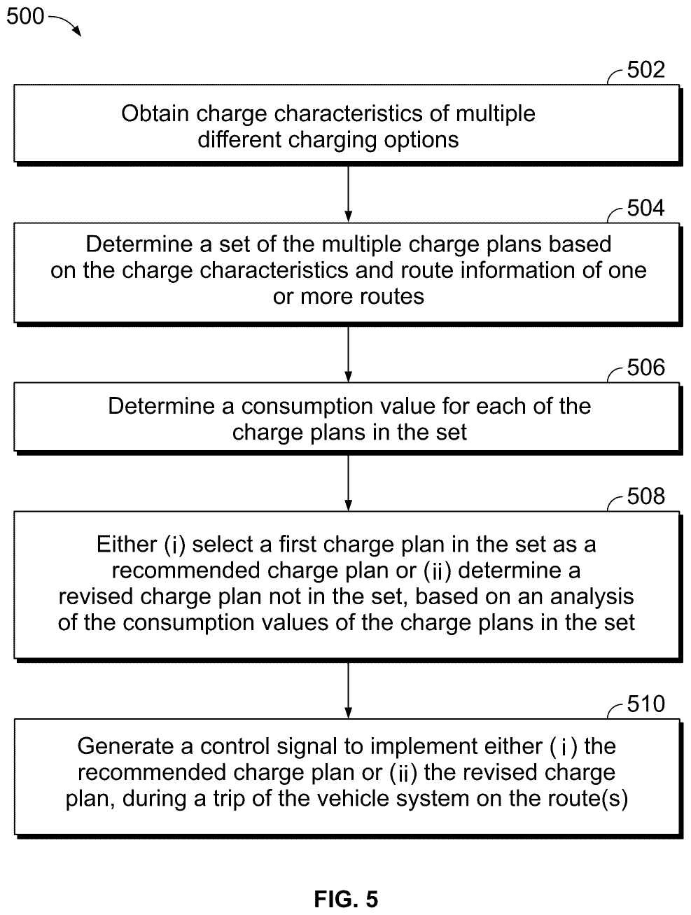

FIG. 5 is a flow chart of a method 500 of controlling power transfer to an energy storage module onboard a vehicle system along one or more routes according to an embodiment. The method may be performed in whole or in part by the charging controller of the power transfer control system shown in FIG. 3. The method optionally may include more steps than shown, fewer steps than shown, and/or different steps than shown in FIG. 5.

At step 502, charge characteristics of multiple different charging options are obtained. The charging options are techniques for charging the energy storage module onboard the vehicle system. The charge characteristics may include energy efficiency factors of the charging options and usage constraints of the charging options.

At step 504, a set of multiple charge plans are determined based on the charge characteristics and route information of one or more routes. Each of the charge plans in the set may include a different configuration of one or more of the charging options for the vehicle system to utilize to charge the energy storage module while traveling on the one or more routes.

At step 506, a consumption value is determined for each of the charge plans in the set. The consumption value for each of the charge plans represents an estimated fuel consumption of the vehicle system on the trip, an estimated fuel savings of the vehicle system on the trip, an estimated battery life consumption of the vehicle system on the trip, an estimated travel time of the vehicle system on the trip, and/or an estimated vehicle equipment wear on the trip, according to the respective charge plan.

At step 508, a first charge plan in the set is selected as a recommended charge plan, or a revised charge plan, that is not in the set, is determined. In either case, the charge plan that is selected or generated is based on an analysis of the consumption values of the charge plans in the set. At step 510, a control signal is generated for the vehicle system to implement the first/recommended charge plan or the revised charge plan during a trip of the vehicle system.

In one or more embodiments, a power transfer control system is provided that includes one or more processors configured to obtain charge characteristics of multiple different charging options for charging an energy storage module onboard a vehicle system. The charge characteristics may include energy efficiency factors of the charging options and usage constraints of the charging options. The one or more processors may determine a charge plan for the vehicle system to implement while traveling on one or more routes based on the charge characteristics and route information of the one or more routes. The charge plan may designate charging the energy storage module via a first charging option of the charging options along a first segment of the one or more routes and charging the energy storage module via a second charging option of the charging options along a different, second segment of the one or more routes. The one or more processors may generate a control signal based on the charge plan.

Optionally, the control signal may be generated for transmission to a vehicle controller for the vehicle controller to control charging of the energy storage module as the vehicle system travels along the one or more routes. Optionally, the control signal may be generated to send a message to an operator of the vehicle system. The message may indicate control settings for the vehicle system to implement along the one or more routes to charge the energy storage module. Optionally, the control signal may be generated to recommend at least one of equipment to install on the vehicle system or infrastructure to install along the one or more routes to enable use of at least one of the charging options for charging the energy storage module as the vehicle system travels along the one or more routes.

Optionally, the first segment of the one or more routes represents a first scheduled trip of the vehicle system, and the second segment of the one or more routes represents a second scheduled trip of the vehicle system. The charge plan may be a first charge plan determined by the one or more processors. The one or more processors may determine a second charge plan that designates charging the energy storage module via only the first charging option along both the first and second segments of the one or more routes. The one or more processors may generate the control signal to recommend one of the first charge plan or the second charge plan.

Optionally, the charge plan may be a first charge plan of a set of multiple charge plans that are determined by the one or more processors. Each of the charge plans in the set may include a different configuration of one or more of the charging options for the vehicle system to utilize to charge the energy storage module while traveling on the one or more routes. The one or more processors may determine an estimated fuel savings for each of the charge plans in the set, and may select the first charge plan from other charge plans in the set based on the first charge plan having a greater estimated fuel savings that one or more of the other charge plans.

The charging options may include at least two of dynamic braking, consist dragging, an inter-vehicle transmission line, an intra-vehicle transmission line, and an extra-vehicle transmission line. One of the usage constraints associated with the extra-vehicle transmission line may include an identification of one or more segments of the one or more routes that have the extra-vehicle transmission line present and are available for use by the vehicle system. The one or more processors may determine the charge plan to cause the vehicle system to travel along the one or more routes with greater energy efficiency relative to the vehicle system traveling along the one or more routes using only dynamic braking to charge the energy storage module.

Optionally, the energy storage module may be disposed onboard a first vehicle of the vehicle system, and at least some of the charging options have different electrical power sources. The electrical power sources may include at least two of (i) a generator onboard the first vehicle and powered by a first engine onboard the first vehicle, (ii) one or more traction motors onboard the first vehicle in a dynamic braking mode of operation, (iii) a second generator onboard a second vehicle of the vehicle system and powered by a second engine onboard the second vehicle, and (iv) an external power supply system off-board the vehicle system. Optionally, the vehicle system may include a first propulsion-generating vehicle mechanically coupled to a second propulsion-generating vehicle. The energy storage module may be disposed onboard the first propulsion-generating vehicle, and at least one of the charging options may include charging the energy storage module based on operation of a combustion engine disposed onboard the second propulsion-generating vehicle.

Optionally, an incline grade segment of the one or more routes may follow the first segment and may be before the second segment relative to a travel direction of the vehicle system. The first charging option may include charging the energy storage module via operation of a combustion engine of the vehicle system using one or more of consist dragging, an inter-vehicle transmission line, or an intra-vehicle transmission line. The first charging option may be performed for the energy storage module to have sufficient charge to power propulsion of the vehicle system up the incline grade segment. The second segment of the one or more routes may have a decline grade, and the second charging option may be dynamic braking performed as the vehicle system travels along the decline grade.

In one or more embodiments, a power transfer control system includes one or more processors configured to obtain charge characteristics of multiple different charging options for charging an energy storage module onboard a vehicle system. The charge characteristics may include energy efficiency factors of the charging options and usage constraints of the charging options. The one or more processors may determine a set of multiple charge plans based on the charge characteristics and route information of one or more routes. Each of the charge plans in the set may include a different configuration of one or more of the charging options for the vehicle system to utilize to charge the energy storage module while traveling on the one or more routes. The one or more processors may determine a consumption value for each of the charge plans in the set, and one of: (i) select a first charge plan in the set or (ii) determine a revised charge plan that is not in the set, based on an analysis of the consumption values of the charge plans in the set. The one or more processors may generate a control signal for the vehicle system to implement the first charge plan or the revised charge plan during a trip of the vehicle system.

Optionally, the consumption value for each of the charge plans may represent one or more of an estimated fuel consumption of the vehicle system on the trip, an estimated fuel savings of the vehicle system on the trip, an estimated battery life consumption of the vehicle system on the trip, an estimated travel time of the vehicle system on the trip, or an estimated vehicle equipment wear on the trip, according to the respective charge plan.

Optionally, the first charge plan or the revised charge plan may designate charging the energy storage module via a first charging option of the charging options along a first segment of the one or more routes during the trip and charging the energy storage module via a second charging option of the charging options along a different, second segment of the one or more routes during the trip. Optionally, the vehicle system includes a first propulsion-generating vehicle mechanically coupled to a second propulsion-generating vehicle. The energy storage module may be disposed onboard the first propulsion-generating vehicle, and at least one of the charging options may include charging the energy storage module based on operation of a combustion engine disposed onboard the second propulsion-generating vehicle.

Optionally, the control signal may be transmitted to a vehicle controller to control movement of the vehicle system along the one or more routes according to the first charge plan that is selected or the revised charge plan that is determined. Optionally, the control signal may be generated to send a message to an operator of the vehicle system. The message may indicate control settings for the vehicle system to implement along the one or more routes to charge the energy storage module during the trip according to the first charge plan that is selected or the revised charge plan that is determined. Optionally, the first charge plan in the set that is selected or the revised charge plan that is determined may be based on prospective charging infrastructure that is not currently present along one or more segments of the one or more routes. The control signal that is generated may recommend installing the prospective charging infrastructure along the one or more segments.

Optionally, the charging options may include at least two of dynamic braking, consist dragging, an inter-vehicle transmission line, an intra-vehicle transmission line, and an extra-vehicle transmission line. The one or more processors may select the first charge plan or determine the revised charge plan for the vehicle system to travel along the one or more routes with greater energy efficiency relative to the vehicle system traveling along the one or more routes using only dynamic braking to charge the energy storage module.

Optionally, the energy storage module is disposed onboard a first vehicle of the vehicle system, and at least some of the charging options may have different electrical power sources. The electrical power sources may include at least two of (i) a generator onboard the first vehicle and powered by a first engine onboard the first vehicle, (ii) one or more traction motors onboard the first vehicle in a dynamic braking mode of operation, (iii) a second generator onboard a second vehicle of the vehicle system and powered by a second engine onboard the second vehicle, and (iv) an external power supply system off-board the vehicle system.

In one or more embodiments, a method for determining and implementing a charge plan includes obtaining charge characteristics of multiple different charging options for charging an energy storage module onboard a vehicle system. The charge characteristics may include energy efficiency factors of the charging options and usage constraints of the charging options. The method may include determining, via one or more processors, a charge plan for the vehicle system to implement while traveling on one or more routes based on the charge characteristics and route information of the one or more routes. The charge plan may designate charging the energy storage module via a first charging option of the charging options along a first segment of the one or more routes and charging the energy storage module via a second charging option of the charging options along a different, second segment of the one or more routes. The method may include generating a control signal based on the charge plan.

Optionally, the method may include transmitting the control signal to a vehicle controller for the vehicle controller to control charging of the energy storage module as the vehicle system travels along the one or more routes. Optionally, the control signal may be generated to transmit a message to an operator of the vehicle system. The message may indicate control settings for the vehicle system to implement along the one or more routes to charge the energy storage module. Optionally, the control signal may be generated to recommend at least one of equipment to install on the vehicle system or infrastructure to install along the one or more routes to enable use of at least one of the charging options for charging the energy storage module as the vehicle system travels along the one or more routes.

Optionally, the charge plan that is determined is a first charge plan, and the method may include determining a second charge plan that designates charging the energy storage module via only the first charging option along both the first and second segments of the one or more routes. The control signal may be generated to recommend one of the first charge plan or the second charge plan to be implemented by the vehicle system along the one or more routes.

Optionally, the charge plan is a first charge plan of a set of multiple charge plans, and the method may include determining other charge plans in the set for the vehicle system to implement while traveling on the one or more routes. Each of the charge plans in the set may have a different configuration of one or more of the charging options for the vehicle system to utilize to charge the energy storage module while traveling on the one or more routes. The method may include determining an estimated fuel savings for each of the charge plans in the set, and selecting the first charge plan from the other charge plans in the set based on the first charge plan having a greater estimated fuel savings that one or more of the other charge plans.

Optionally, the charging options may include at least two of dynamic braking, consist dragging, an inter-vehicle transmission line, an intra-vehicle transmission line, and an extra-vehicle transmission line. Optionally, determining the charge plan may include determining one or more of when, where, or how to charge the energy storage module to cause the vehicle system to travel along the one or more routes with greater energy efficiency relative to the vehicle system traveling along the one or more routes using only dynamic braking to charge the energy storage module. Optionally, at least one of the first or second charging options may include charging the energy storage module disposed onboard a first propulsion-generating vehicle of the vehicle system based on operation of a combustion engine disposed onboard a second propulsion-generating vehicle of the vehicle system.

Optionally, the energy storage module is disposed onboard a first vehicle of the vehicle system, and at least some of the charging options may have different electrical power sources. The electrical power sources may include at least two of (i) a generator onboard the first vehicle and powered by a first engine onboard the first vehicle, (ii) one or more traction motors onboard the first vehicle in a dynamic braking mode of operation, (iii) a second generator onboard a second vehicle of the vehicle system and powered by a second engine onboard the second vehicle, and (iv) an external power supply system off-board the vehicle system.

Optionally, an incline grade segment of the one or more routes may follow the first segment and may precede the second segment relative to a travel direction of the vehicle system. The first charging option may include charging the energy storage module via operation of a combustion engine of the vehicle system using one or more of consist dragging, an inter-vehicle transmission line, or an intra-vehicle transmission line. Generating the control signal may include instructing the vehicle system to charge the energy storage module according to the first charging option as the vehicle system travels along the first segment for the energy storage module to have sufficient charge to power propulsion of the vehicle system up the incline grade segment. Optionally, the second segment of the one or more routes may have a decline grade, and generating the control signal may include instructing the vehicle system to charge the energy storage module according to the second charging option as the vehicle system travels along the decline grade. The second charging option may be dynamic braking.

In one or more embodiments, a method for determining and implementing a charge plan may include obtaining charge characteristics of multiple different charging options for charging an energy storage module onboard a vehicle system. The charge characteristics may include energy efficiency factors of the charging options and usage constraints of the charging options. The method may include determining, via one or more processors, a set of multiple charge plans based on the charge characteristics and route information of one or more routes. Each of the charge plans in the set may have a different configuration of one or more of the charging options for the vehicle system to utilize to charge the energy storage module while traveling on the one or more routes. The method may include determining a consumption value for each of the charge plans in the set, and one of: (i) selecting a first charge plan in the set or (ii) determining a revised charge plan that is not in the set, based on an analysis of the consumption values of the charge plans in the set. The method may include generating a control signal for the vehicle system to implement the first charge plan or the revised charge plan during a trip of the vehicle system.

Optionally, the consumption value for each of the charge plans represents one or more of an estimated fuel consumption of the vehicle system on the trip, an estimated fuel savings of the vehicle system on the trip, an estimated battery life consumption of the vehicle system on the trip, an estimated travel time of the vehicle system on the trip, or an estimated vehicle equipment wear on the trip, according to the respective charge plan.

Optionally, the first charge plan that is selected or the revised charge plan that is determined may designate charging the energy storage module via a first charging option of the charging options along a first segment of the one or more routes during the trip and charging the energy storage module via a second charging option of the charging options along a different, second segment of the one or more routes during the trip.

The method may include transmitting the control signal to a vehicle controller to control movement of the vehicle system along the one or more routes according to the first charge plan that is selected or the revised charge plan that is determined. Optionally, the control signal may be generated to send a message to an operator of the vehicle system. The message may indicate control settings for the vehicle system to implement along the one or more routes during the trip according to the first charge plan that is selected or the revised charge plan that is determined. Optionally, the first charge plan in the set that is selected or the revised charge plan that is determined may be based on prospective charging infrastructure that is not currently present along one or more segments of the one or more routes. The control signal may be generated to recommend installing the prospective charging infrastructure along the one or more segments.

Optionally, the selecting the first charge plan or determining the revised charge plan may include determining one or more of when, where, or how to charge the energy storage module to cause the vehicle system to travel along the one or more routes with greater energy efficiency relative to the vehicle system traveling along the one or more routes using only dynamic braking to charge the energy storage module.

Optionally, the charging options may include at least two of dynamic braking, consist dragging, an inter-vehicle transmission line, an intra-vehicle transmission line, and an extra-vehicle transmission line. Optionally, at least one of the charging options may include charging the energy storage module disposed onboard a first propulsion-generating vehicle of the vehicle system based on operation of a combustion engine disposed onboard a second propulsion-generating vehicle of the vehicle system. Optionally, the energy storage module is disposed onboard a first vehicle of the vehicle system, and at least some of the charging options may have different electrical power sources. The electrical power sources may include at least two of (i) a generator onboard the first vehicle and powered by a first engine onboard the first vehicle, (ii) one or more traction motors onboard the first vehicle in a dynamic braking mode of operation, (iii) a second generator onboard a second vehicle of the vehicle system and powered by a second engine onboard the second vehicle, and (iv) an external power supply system off-board the vehicle system.

In one embodiment, the controllers or systems described herein may have a local data collection system deployed and may use machine learning to enable derivation-based learning outcomes. The controllers may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used making determinations, calculations, comparisons and behavior analytics, and the like. For example, the charge controller of the electrical power transfer system described herein may use machine learning to enable generating the charge plan(s) based on the input information (e.g., charge characteristics and route information).

In one embodiment, the controllers may include a policy engine that may apply one or more policies. These policies may be based at least in part on characteristics of a given item of equipment or environment. With respect to control policies, a neural network can receive input of a number of environmental and task-related parameters. These parameters may include, for example, operational input regarding operating equipment, data from various sensors, location and/or position data, and the like. The neural network can be trained to generate an output based on these inputs, with the output representing an action or sequence of actions that the equipment or system should take to accomplish the goal of the operation. During operation of one embodiment, a determination can occur by processing the inputs through the parameters of the neural network to generate a value at the output node designating that action as the desired action. This action may translate into a signal that causes the vehicle to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

As used herein, the terms “processor” and “computer,” and related terms, e.g., “processing device,” “computing device,” and “controller” may be not limited to just those integrated circuits referred to in the art as a computer, but refer to a microcontroller, a microcomputer, a programmable logic controller (PLC), field programmable gate array, and application specific integrated circuit, and other programmable circuits. Suitable memory may include, for example, a computer-readable medium. A computer-readable medium may be, for example, a random-access memory (RAM), a computer-readable non-volatile medium, such as a flash memory. The term “non-transitory computer-readable media” represents a tangible computer-based device implemented for short-term and long-term storage of information, such as, computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. As such, the term includes tangible, computer-readable media, including, without limitation, non-transitory computer storage devices, including without limitation, volatile and non-volatile media, and removable and non-removable media such as firmware, physical and virtual storage, CD-ROMS, DVDs, and other digital sources, such as a network or the Internet.

The singular forms “a”, “an”, and “the” include plural references unless the context clearly dictates otherwise. “Optional” or “optionally” means that the subsequently described event or circumstance may or may not occur, and that the description may include instances where the event occurs and instances where it does not. Approximating language, as used herein throughout the specification and claims, may be applied to modify any quantitative representation that could permissibly vary without resulting in a change in the basic function to which it may be related. Accordingly, a value modified by a term or terms, such as “about,” “substantially,” and “approximately,” may be not to be limited to the precise value specified. In at least some instances, the approximating language may correspond to the precision of an instrument for measuring the value. Here and throughout the specification and claims, range limitations may be combined and/or interchanged, such ranges may be identified and include all the sub-ranges contained therein unless context or language indicates otherwise.

This written description uses examples to disclose the embodiments, including the best mode, and to enable a person of ordinary skill in the art to practice the embodiments, including making and using any devices or systems and performing any incorporated methods. The claims define the patentable scope of the disclosure, and include other examples that occur to those of ordinary skill in the art. Such other examples are intended to be within the scope of the claims if they have structural elements that do not differ from the literal language of the claims, or if they include equivalent structural elements with insubstantial differences from the literal language of the claims.

What is claimed is:

1. A power transfer control system comprising:
one or more processors configured to:
obtain charge characteristics of multiple different charging options for charging an energy storage module onboard a vehicle system, the charge characteristics comprising energy efficiency factors of the charging options and usage constraints of the charging options;
determine a charge plan for the vehicle system to implement while traveling on one or more routes based on the charge characteristics and route information of the one or more routes, wherein the charge plan designates charging the energy storage module via a first charging option of the charging options along a first segment of the one or more routes and charging the energy storage module via a second charging option of the charging options along a different, second segment of the one or more routes; and
generate a control signal based on the charge plan.

2. The power transfer control system of claim 1, wherein the control signal is generated for transmission to a vehicle controller for the vehicle controller to control charging of the energy storage module as the vehicle system travels along the one or more routes.

3. The power transfer control system of claim 1, wherein the control signal is generated to send a message to an operator of the vehicle system, the message indicating control settings for the vehicle system to implement along the one or more routes to charge the energy storage module.

4. The power transfer control system of claim 1, wherein the control signal is generated to recommend at least one of equipment to install on the vehicle system or infrastructure to install along the one or more routes to enable use of at least one of the charging options for charging the energy storage module as the vehicle system travels along the one or more routes.

5. The power transfer control system of claim 1, wherein the first segment of the one or more routes represents a first scheduled trip of the vehicle system, and the second segment of the one or more routes represents a second scheduled trip of the vehicle system.

6. The power transfer control system of claim 1, wherein the charge plan is a first charge plan determined by the one or more processors, and the one or more processors are configured to determine a second charge plan that designates charging the energy storage module via only the first charging option along both the first and second segments of the one or more routes, the one or more processors configured to generate the control signal to recommend one of the first charge plan or the second charge plan.

7. The power transfer control system of claim 1, wherein the charge plan is a first charge plan of a set of multiple charge plans that are determined by the one or more processors, each of the charge plans in the set including a different configuration of one or more of the charging options for the vehicle system to utilize to charge the energy storage module while traveling on the one or more routes, the one or more processors configured to:
determine an estimated fuel savings for each of the charge plans in the set, and
select the first charge plan from other charge plans in the set based on the first charge plan having a greater estimated fuel savings that one or more of the other charge plans.

8. The power transfer control system of claim 1, wherein the charging options comprise at least two of dynamic braking, consist dragging, an inter-vehicle transmission line, an intra-vehicle transmission line, and an extra-vehicle transmission line.

9. The power transfer control system of claim 8, wherein one of the usage constraints associated with the extra-vehicle transmission line includes an identification of one or more segments of the one or more routes that have the extra-vehicle transmission line present and available for use by the vehicle system.

10. The power transfer control system of claim 1, wherein the one or more processors are configured to determine the charge plan to cause the vehicle system to travel along the one or more routes with greater energy efficiency relative to the vehicle system traveling along the one or more routes using only dynamic braking to charge the energy storage module.

11. The power transfer control system of claim 1, wherein the energy storage module is disposed onboard a first vehicle of the vehicle system, and at least some of the charging options have different electrical power sources, the electrical power sources comprising at least two of (i) a generator onboard the first vehicle and powered by a first engine onboard the first vehicle, (ii) one or more traction motors onboard the first vehicle in a dynamic braking mode of operation, (iii) a second generator onboard a second vehicle of the vehicle system and powered by a second engine onboard the second vehicle, and (iv) an external power supply system off-board the vehicle system.

12. The power transfer control system of claim 1, wherein an incline grade segment of the one or more routes follows the first segment and is before the second segment relative to a travel direction of the vehicle system, the first charging option includes charging the energy storage module via operation of a combustion engine of the vehicle system using one or more of consist dragging, an inter-vehicle transmission line, or an intra-vehicle transmission line, the first charging option performed for the energy storage module to have sufficient charge to power propulsion of the vehicle system up the incline grade segment.

13. The power transfer control system of claim 12, wherein the second segment of the one or more routes has a decline grade, and the second charging option is dynamic braking performed as the vehicle system travels along the decline grade.

14. The power transfer control system of claim 1, wherein the vehicle system includes a first propulsion-generating vehicle mechanically coupled to a second propulsion-generating vehicle, the energy storage module disposed onboard the first propulsion-generating vehicle, at least one of the charging options comprises charging the energy storage module based on operation of a combustion engine disposed onboard the second propulsion-generating vehicle.

15. A method comprising:
obtaining charge characteristics of multiple different charging options for charging an energy storage module onboard a vehicle system, the charge characteristics comprising energy efficiency factors of the charging options and usage constraints of the charging options;
determining, via one or more processors, a charge plan for the vehicle system to implement while traveling on one or more routes based on the charge characteristics and route information of the one or more routes, wherein the charge plan designates charging the energy storage module via a first charging option of the charging options along a first segment of the one or more routes and charging the energy storage module via a second charging option of the charging options along a different, second segment of the one or more routes; and
generating a control signal based on the charge plan.

16. The method of claim 15, further comprising transmitting the control signal to a vehicle controller for the vehicle controller to control charging of the energy storage module as the vehicle system travels along the one or more routes.

17. The method of claim 15, wherein at least one of the first or second charging options comprises charging the energy storage module disposed onboard a first propulsion-generating vehicle of the vehicle system based on operation of a combustion engine disposed onboard a second propulsion-generating vehicle of the vehicle system.

18. A power transfer control system comprising:
one or more processors configured to:
obtain charge characteristics of multiple different charging options for charging an energy storage module onboard a vehicle system, the charge characteristics comprising energy efficiency factors of the charging options and usage constraints of the charging options;
determine a set of multiple charge plans based on the charge characteristics and route information of one or more routes, each of the charge plans in the set including a different configuration of one or more of the charging options for the vehicle system to utilize to charge the energy storage module while traveling on the one or more routes;
determine a consumption value for each of the charge plans in the set;
one of: (i) select a first charge plan in the set or (ii) determine a revised charge plan that is not in the set, based on an analysis of the consumption values of the charge plans in the set; and
generate a control signal for the vehicle system to implement the first charge plan or the revised charge plan during a trip of the vehicle system.

19. The power transfer control system of claim 18, wherein the consumption value for each of the charge plans represents one or more of an estimated fuel consumption of the vehicle system on the trip, an estimated fuel savings of the vehicle system on the trip, an estimated battery life consumption of the vehicle system on the trip, an estimated travel time of the vehicle system on the trip, or an estimated vehicle equipment wear on the trip, according to the respective charge plan.

20. The power transfer control system of claim 18, wherein the first charge plan or the revised charge plan designates charging the energy storage module via a first charging option of the charging options along a first segment of the one or more routes during the trip and charging the energy storage module via a second charging option of the charging options along a different, second segment of the one or more routes during the trip.
